(19) United States
(12) Patent Application Publication
(10) Pub. No.: US 2020/0410210 A1
(43) Pub. Date: Dec. 31, 2020

(54) POSE INVARIANT FACE RECOGNITION

(71) Applicant: CARNEGIE MELLON UNIVERSITY, Pittsburgh, PA (US)

(72) Inventors: Marios Savvides, Pittsburgh, PA (US); Chandrasekhar Bhagavatula, Pittsburgh, PA (US); Chi Nhan Duong, Pittsburgh, PA (US)

(21) Appl. No.: 16/976,389

(22) PCT Filed: Mar. 12, 2019
(86) PCT No.: PCT/US19/21790

§ 371 Date: Aug. 27, 2020

Related U.S. Application Data
(60) Provisional application No. 62/761,141, filed on Mar. 12, 2018.

(51) Int. Cl. G06K 9/00; G06T 19/20

(52) U.S. Cl. CPC G06K 9/00228; G06T 2219/2004; G06K 9/00926; G06T 19/20

(57) ABSTRACT

The disclosed method generates a pose invariant feature by normalizing off-angle faces to generate a pose invariant input image. Any face recognition mode can be used with this pre processing step. In this method, method, the 3D Spatial Transformer Networks is used to extract a 3D model of the face from an input at any pose.

### RELATED APPLICATIONS

This application claims the benefit of U.S. Provisional Application No. 62/761,141, filed Mar. 12, 2018, which is incorporated herein by reference in its entirety.

### GOVERNMENT RIGHTS

This invention was made with government support under N6833516C0177 awarded by the Navy. The government has certain rights in the invention.

### BACKGROUND OF THE INVENTION

Deep learning has shown a great improvement in many image-based tasks, including face recognition. With the advent of larger and larger training and evaluation datasets, many models are able to show very impressive results on “in-the-wild” images. However, these same models often do not perform nearly as well when dealing with large pose variations between the enrollment and probe images. This kind of scenario commonplace in the real world. In applications such law enforcement, especially when dealing with repeat offenders, a frontal mugshot image of the subject is available as a gallery image. However, the acquired image that needs to be matched is often at a non-frontal, possibly even profile, pose.

There have been many approaches in the past to dealing with pose invariant face recognition. Generally, these methods have fallen into two categories, pose synthesis and pose correction. In a pose synthesis framework, the face is rendered at a similar angle as the probe image and matched. In pose correction, the off-angle face is rendered from a frontal viewpoint to match only in a frontal-to-frontal setting. The main difference between these two approaches is that in the pose correction setting, some method of dealing with the self-occluded regions of the face must be used. Many times, these self-occluded regions are either reconstructed using some sort of generative model or just left black and the recognition method itself is left to learn how to deal with the missing regions. However, both of these methods still generate a pose varying input to the recognition system as the self-occluded region grows as the pose gets further and further away from a frontal image, as can be seen in FIG. 1.

Previous methods have focused on developing highly discriminative frameworks for face embeddings through joint Bayesian modeling, high dimensional LBP embeddings, high dimensional SIFT embeddings with a learned projection and large scale CMD and SLBP descriptor usage. There have also been methods developed that focus more on invoking invariance towards nuisance transformations explicitly. Though these methods utilized group theoretic invariance modeling and are theoretically grounded, their application to large scale real-world problems is limited.

With the onset of deep learning approaches in vision, almost all recent high-performing methods have converged towards the framework. Early works used Siamese networks to extract features for pair-wise matching. Large-scale efforts have emerged relatively recently with networks becoming deeper and involving more training data. As deep network applications grew in popularity in face recognition, efforts switched focus on pure and augmented metric learning based approaches which provided additional supervision signals. Large margin learning was another direction that was explored for fa.cc recognition.

More recently, efforts also focused attention on feature normalization and its implications. Feature normalization helps rectifying the class imbalance problem during training, which is especially a problem for applications such as face recognition with its large number of classes and fewer samples per class, compared to object classification benchmarks. However, even though many of these works have progressively achieved state-of-the-art results on multiple datasets, they do not explicitly address core nuisance variations such as pose. Existing biases in current evaluation benchmarks towards frontal images hide this limitation and generate a potentially false understanding of success in face verification. Though such systems might be useful applications such as social media, they are expected to fail in more challenging settings such as law enforcement where pose variation is coupled with extreme degradation in resolution, illumination etc.

### BRIEF DESCRIPTION OF THE DRAWINGS

FIG. 1 shows frontalizations of one subject from the MPIE dataset. Original images (1st and 4th rows), frontalizations (2nd and 4th rows), and frontalizations with self-occluded regions blacked out (3rd and 6th rows). The top three rows show the right facing poses from 0° Lo 90° in 15° increments. The bottom three rows show the left facing poses 0° to −90° in 15° increments.

FIG. 2 shows standard deviation in the pixel values of (a) the right facing poses and (b) the left facing poses when frontalized.

FIG. 3 shows original images of one subject from the MPIE dataset (1^{st} and 3^{rd} rows) and corresponding half face (2^{nd} and 4^{th} rows). The half-faces arc fairly consistent all the way to 60° and start to change thereafter. This is due to the mold fitting starting to fail at the more extreme angles.

FIG. 4 shows ROC curves for whole face and half-face models at various angles of rotation for the images in the MPIE dataset.

### DETAILED DESCRIPTION

Instead of relying on a network to handle pose varying inputs, the disclosed method uses whichever half of the face is visible at the probe angle to match back to the frontal image. In this way, the method only needs to match very similar faces and can get a high improvement in face recognition accuracy across pose.

To truly generate a pose invariant feature, off-angle faces can be normalized to generate a pose invariant input image. By approaching the pose invariant face recognition problem from this aspect, any face recognition mode can be used with this data preprocessing step. However, as off-angle faces are inherently rotating out of the camera plane, it is very important to incorporate an understanding of the 3D structure of the face when doing a normalization. In this method, method, the 3D Spatial Transformer Networks is used to extract a 3D model of the face from an input at any pose.

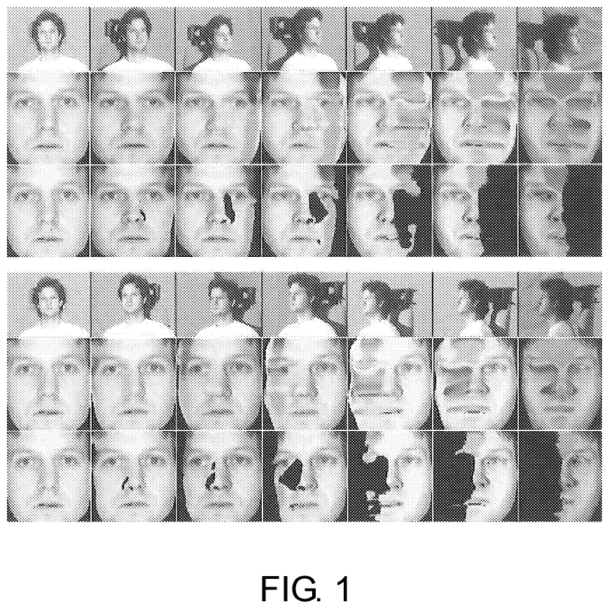

Once a 3D model has been generated, the face can be rendered from a frontal viewpoint as shown in FIG. 1. The nonvisible regions of the model cannot be extracted from the input image and a naive sampling of the image leads to very unrealistic faces.

Because the method laid out in prior art methods provides an estimate for the camera parameters, a pose estimate can easily be obtained at the same time. Using this pose estimate, the non-visible regions can be masked out of the image. The remaining regions are much more realistic, but these images still suffer the problem of varying as the pose of the face changes. This will also lead to a pose varying feature which the face recognition model will have to compensate for. As convolutional neural networks deal very well with translation in the features and this normalization turns out-of-plane rotation into a missing data and 2D alignment problem, this may be better for these types of networks.

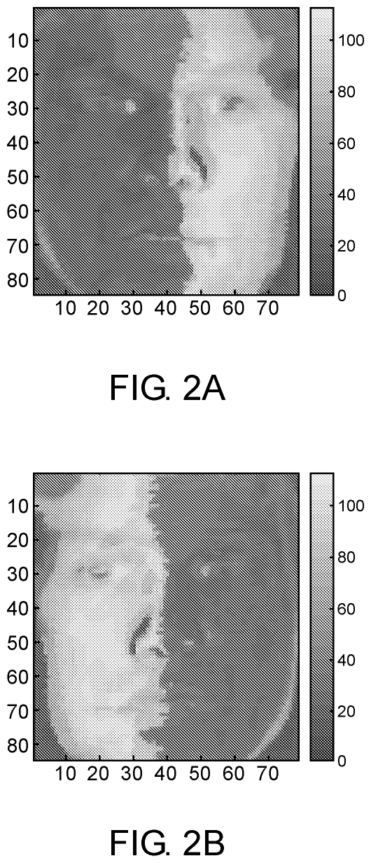

However, as the goal here is to have a truly pose invariant input, the issue of the masked-out regions must be addressed. By looking at the masked versions of the frontalizations, it becomes very clear that only one side of the face really changes as the pose changes away from a frontal angle. In other words, as the face points to the left, the left side of the face remains very aligned and stable while the right half disappears and vice versa. This can be easily confirmed by looking at the standard deviation of the pixel values of the images for both the left and right facing images as shown in FIG. 2.

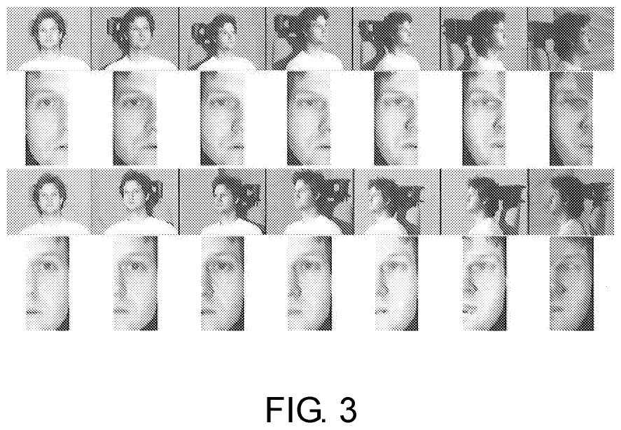

From this, it can be seen that the frontalization for the right facing poses should only be using the left half of the image and vice versa for the left facing poses. These are the regions of the face that have a much lower standard deviation in pixel value, meaning these halves of the face will be much more consistent across their respective poses. The resulting “half-faces”, as referred to herein, appear much more similar than the original frontalizations, as can be seen in FIG. 3. Such a normalization allows the use of any model to train a pose invariant face matcher without the need for changes in the underlying architecture.

Because the frontalization is performed on the input image, any face recognition model can be trained to use these frontalized images. For example, a ResNet architecture with 28 layers and a Softmax loss function may be used to train the face recognition model.

The model can be trained on both the frontalized half-faces and the original whole face images aligned by the landmarks extracted. Alternatively, the models may be trained using only the original whole-face images. An initial learning rate of 0.1 may be used and drops by a factor of 0.1 every 15 epochs. The models are trained on the CASIA-WebFace dataset with a 90%-10% split for training and validation.

To verify the efficacy of the method of frontalization, experiments were conducted using the CMU MPIE dataset, consisting of images of 337 subjects under different poses, illuminations, and expressions. The yaw angle of the images varies from −90° to 90° in 15° increments. The 0°, neutral expression images were used as a gallery for the experiments.

The non-frontal, neutral illumination and expression images were used as a set of probe images. because a frontal image is used as the gallery, the correct half of the face can be sampled no matter which pose in in the probe set. As a result, the left half of the gallery faces were compared to the left half-faces generated in the probe set and the right half of the gallery faces to the right-half faces generated in the probe set. As can be seen in Table 1, the half face normalization outperforms using the original whole face data at every pose in the Rank-1 recognition accuracy.

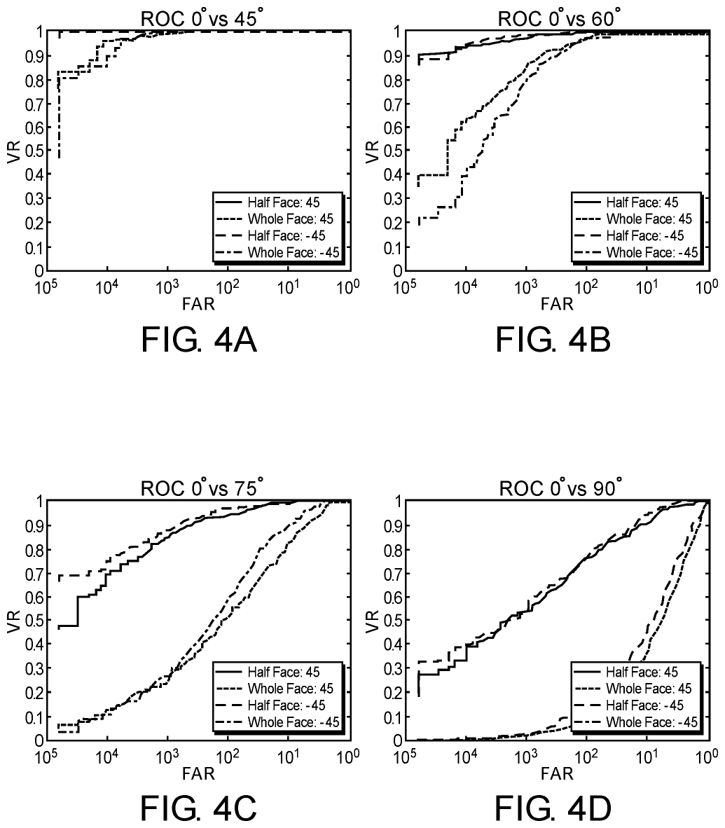

This is especially true at the extreme poses of ±75° and ±90° where the whole face image is the most different from the gallery frontal image. This can also be seen in the ROC curves comparing the whole face model to the half face model in FIG. 4. It becomes very clear that, as the pose increases, the ROC curves for the whole face model drop much faster than the curves for the half-face model. This method of preprocessing has thus significantly improved pose tolerance in the same model.

TABLE 1

| Method | 15° | 30° | 45° | 60° | 75° | 90° | −15° | −30° | −45° | −60° | −75° | −90° |
|---|---|---|---|---|---|---|---|---|---|---|---|---|
| Whole Face | 1.000 | 1.000 | 0.996 | 0.980 | 0.518 | 0.036 | 1.000 | 1.000 | 1.000 | 0.980 | 0.578 | 0.093 |
| Half Face | 1.000 | 1.000 | 1.000 | 0.992 | 0.936 | 0.696 | 1.000 | 1.000 | 1.000 | 0.988 | 0.940 | 0.722 |

Table 1 shows the Rank-1 recognition on the MPIE dataset using the method. It is possible to vastly improve face recognition with some very simple pre-processing steps. By incorporating a 3D understanding of faces into the face recognition process itself and carefully selecting the regions to show a model, input images can be generated that are much more pose tolerant than the originals. The same architectures can generate much more pose tolerant results by using “half-face” input images for matching. By using such a pre-processing step, one can achieve very high accuracy for off-angle face recognition with relatively small datasets such as the CASIA WebFace dataset.

We claim:

1. A method for normalizing off-angle facial images to frontal views comprising:
receiving a facial image, the facial image rotated off-angle from a directly frontal view;
generating a 3D model of the face represented in the facial image from the facial image;
adjusting the 3D model to represent the face from a frontal viewpoint;
creating a 2D frontal image from the 3D model, the 2D image having masked areas representing occluded areas of the facial image; and
creating a half-face image from the 2D image;

2. The method of claim 1 wherein the 3D model of the face is generated using a 3D Spatial Transformer Network.

3. The method of claim 1 wherein 2D frontal image comprises a left half and a right half and further wherein one of the left half or the right half includes masked areas.

4. The method of claim 3 wherein the half-face image comprises a half of the 2D frontal image not having masked areas.

5. The method of claim 3 wherein the half-face image is created using a left half of the 2D image for right-facing poses and a right half of the 2D image for left-facing poses.

6. The method of claim 1 further comprising:
obtaining a pose estimate of the facial image;
determining non-visible regions of the facial image based on the pose estimate; and
masking the non-visible regions of the facial image.

7. The method of claim 1 further comprising:
training a facial recognition model using a full-frontal view for each facial image in the training set.

8. The method of claim 7 further comprising:
training the facial recognition model further using one or more half-face images corresponding to the full-frontal view for each facial image in the training set.

9. The method of claim 8 wherein the full-frontal view and the one or more half-face images are aligned using landmarks extracted from the 3D model.

10. The method of claim 1 further comprising:
submitting the half-face image as a probe image to a facial recognition model.
